(19) United States
(12) Patent Application Publication
(10) Pub. No.: US 2009/0222770 A1
(43) Pub. Date: Sep. 3, 2009

(54) METHOD OF INPUTTING CONTROL INSTRUCTION AND HANDHELD DEVICE THEREOF

(75) Inventor: Chuan-Yi Chang, Taipei County (TW)

Correspondence Address: Muncy, Geissler, Olds & Lowe, PLLC, P.O. BOX 1364, FAIRFAX, VA, 22038-1364, US

(73) Assignee: INVENTEC APPLIANCES CORP.

(21) Appl. No.: 12/393,484

(22) Filed: Feb. 26, 2009

(30) Foreign Application Priority Data
Feb. 29, 2008 (TW) 097107063

(51) Int. Cl. G06F 3/01

(52) U.S. Cl. 715/863

(57) ABSTRACT

A method of inputting a control instruction and a handheld device thereof are provided. The handheld device includes a memory unit, a touch module, and a recognition module. The method includes receiving a writing track input by the user from a touch module, analyzing the writing track by the recognition module to convert the writing track into a track data, and comparing the track data with a feature data stored in the memory unit to judge whether the two are consistent with each other, so as to determine whether to execute a program instruction corresponding to the feature data. Through the handheld device and method, when a user inputs a writing track, the handheld device activates a corresponding application program and specific actions thereof, so as to reduce the time of searching for the application program, thereby enhancing the practicability of the handheld device to the user.

### CROSS-REFERENCE TO RELATED APPLICATION

This application claims the benefit of Taiwan Patent Application No. 097107063, filed on Feb. 29, 2008, which is hereby incorporated by reference for all purposes as if fully set forth herein.

### BACKGROUND OF THE INVENTION

1. Field of Invention

The present invention relates to a control method and a handheld device thereof, and more particularly, to a method of inputting a control instruction and a handheld device thereof in which when a user inputs a writing track, the handheld device activates a corresponding application program and a specific action thereof.

2. Related Art

At present, for the sake of convenience, leading communication and information enterprises world wide all begin to develop related products of handheld devices, and the handheld device has increasingly diversified functions as a result of great efforts of the enterprises. In addition to previous voice and short message communications, a user may access to the Internet to inquire about required information, perform navigation by using Global Positioning System (GPS), or further execute data synchronous transmission or remote control switches through the connection of the handheld device with the peripheral information and home appliances, and so on.

However, the prior art has inevitable disadvantages, that is, although the handheld device has a lot of functions, but an ordinary user may only require ten percents thereof or even less. Now, the handheld device has a number of function menus, and the function menus may further include multiple ranks of detail function menus. Therefore, a user needs to inquire about one by one to obtain and execute the required function menus.

### SUMMARY OF THE INVENTION

Accordingly, the present invention is directed to provide a method of inputting a control instruction and the handheld device thereof, which may quickly activate a function program required by a user by writing symbols, drawings or texts input by the user.

As embodied and broadly described herein, the present invention provides a handheld device for inputting a control instruction, which is used to activate a program required by a user without opening function menus. The handheld device includes a memory unit, a touch module, and a recognition module. The memory unit stores at least one feature data, at least one application program, and at least one program instruction. Each feature data is corresponding to a program instruction, and the program instruction is used to execute an application program. The touch module is provided for touching to form a writing track. The recognition module obtains and analyzes the writing track to form a track data, and determines whether a feature data consistent with the track data exists in the memory unit, so as to execute the program instruction corresponding to the feature data.

The present invention further provides a method of inputting a control instruction, which is applicable in a handheld device to activate a program required by a user without opening function menus. The method includes receiving a writing track input by the user from a touch module, analyzing the writing track by the recognition module to convert the writing track into the track data, comparing the track data with the feature data stored in a memory unit, and judging whether a feature data consistent with the track data exists, so as to determine whether to execute a program instruction corresponding to the feature data.

The present invention has the following efficacies superior to the prior art.

First, the user may write a text, drawing, or symbol on the touch module intuitively. The handheld device then activates the application program corresponding to the text, drawing, or symbol, so as to execute the specific action required by the user, thus saving time for inquiring about the function menus one by one.

Second, by different matches of texts, drawings and symbols, the handheld device may continuously activate related application programs and execute continuous specific actions.

### BRIEF DESCRIPTION OF THE DRAWINGS

The present invention will become more fully understood from the detailed description given herein below for illustration only, and thus are not limitative of the present invention, and wherein:

FIGS. 1A and 1B are schematic structural views of a handheld device according to an embodiment of the present invention;

FIG. 1C is a flow chart of inputting a control instruction according to an embodiment of the present invention;

FIG. 2 is a schematic view of activating a dialing module according to an embodiment of the present invention;

FIG. 3 is a schematic view of activating a wireless network module according to an embodiment of the present invention;

FIG. 4 is a schematic view of activating a Global Positioning System (GPS) navigation system according to an embodiment of the present invention;

FIG. 5 is a schematic view of activating a real time communication program according to an embodiment of the present invention;

FIG. 6 is a schematic view of inputting multiple writing tracks according to an embodiment of the present invention;

FIG. 7A is a schematic view of configuration of programming an instruction writing module according to the present invention; and

FIG. 7B is a schematic view of operation of the programmed instruction writing module according to the present invention.

### DETAILED DESCRIPTION OF THE INVENTION

In order to provide a further understanding to purposes, structural features, and functions of the present invention, detailed description is given below through related embodiments and drawings.

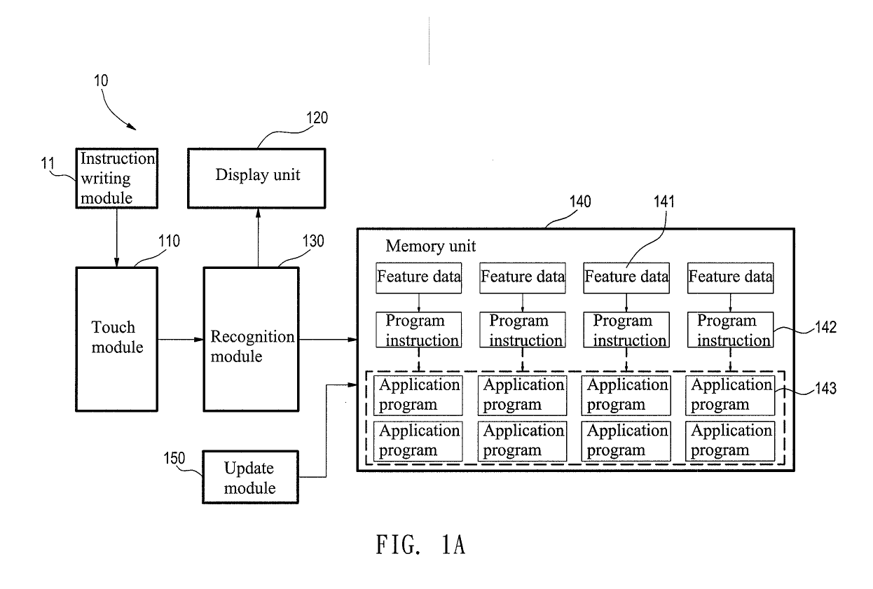

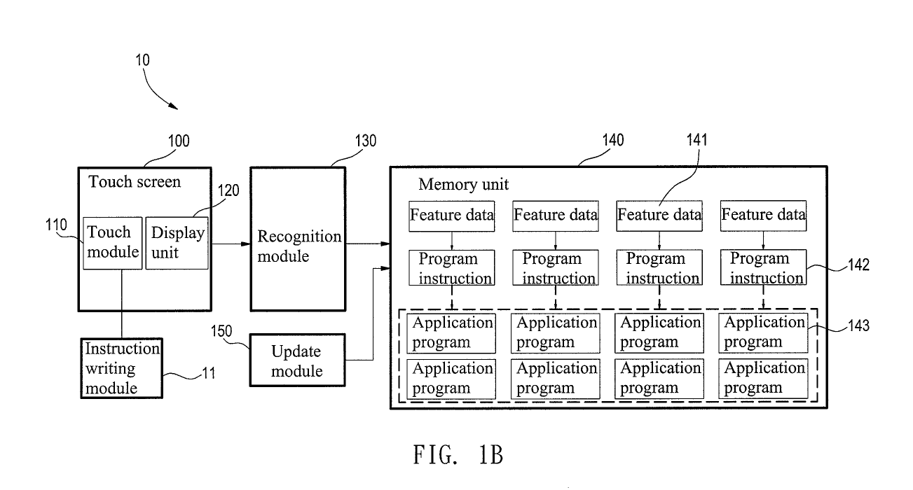

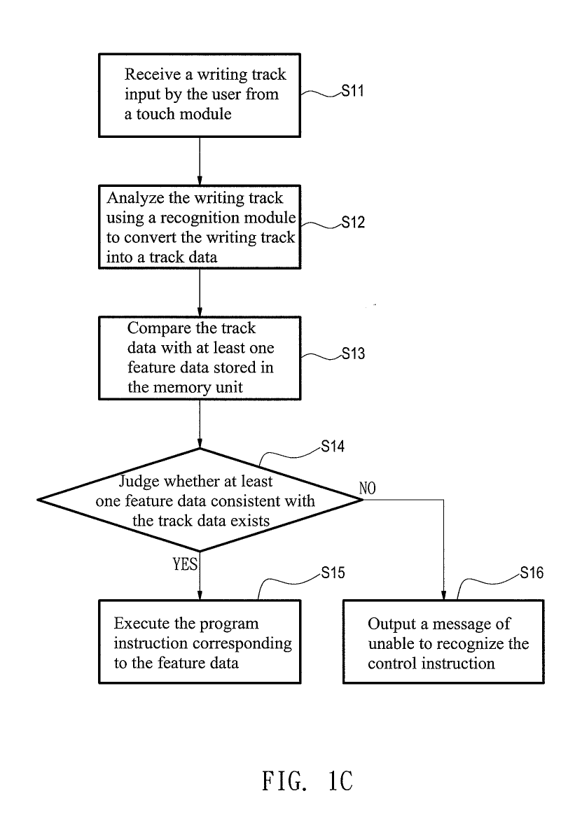

Referring to FIGS. 1A and 1B, schematic structural views of a handheld device according to an embodiment of the present invention are shown. The handheld device is applicable to activate a program required by a user without opening function menus. The handheld device 10 includes an instruction writing module 11, a memory unit 140, a touch module 110, a recognition module 130, an update module 150, and a display unit 120.

The memory unit 140 stores multiple different data, including a feature data 141, a program instruction 142, and an application program 143. Each feature data 141 is corresponding to a program instruction 142, and the program instruction 142 is used to activate an application program 143 to execute a specific action.

The touch module 110 may be a touch panel provided for writing by the user to form a writing track.

The recognition module 130 analyzes the writing track to convert the writing track into a track data and compares the track data with the feature data 141 stored in the memory unit 140, so as to judge whether a feature data 141 consistent with the track data exists. If yes, the feature data 141 consistent with the track data is read, and the program instruction 142 corresponding to the feature data 141 is executed, so as to activate the application program 143 to execute the specific action.

The instruction writing module 11 is used to obtain a control right of the touch module 110 to avoid other application programs 143 from disturbing the input of the control instruction when other application programs 143 require the touch module 110 for text input.

The display unit 120 is used to display the writing track formed by touching the touch module 110, and display an executing state of the application program 143 when the recognition module 130 executes the program instruction 142 corresponding to the feature data 141.

The update module 150 is used to update the feature data 141, the application program 143, and the program instruction 142 stored in the memory unit 140. The update module 150 first obtains a writing track through the touch module 110, converts the writing track into the feature data 141 through the recognition module 130, then directs the feature data 141 to an application program 143 and selects a specific action of the application program 143 to form a program instruction 142, and finally updates the feature data 141 and the corresponding program instruction 142 thereof in the memory unit 140.

The handheld device may be provided with a touch screen 100 including the touch module 110 and the display unit 120, so as to directly display the writing track formed by touching the touch screen 100, and display the executing state of the application program 143 when the recognition module 130 executes the program instruction 142 corresponding to the feature data 141.

The handheld device 10 described in the embodiment may be a mobile phone, a Personal Digital Assistant (PDA), or a notebook electronic apparatus such as a notebook computer. The writing action may be performed on the touch module 110 using a finger or a touch pen.

Referring to FIG. 1C, a flow chart of inputting a control instruction according to an embodiment of the present invention and a detail flow chart thereof are shown. Referring to FIGS. 1A and 1B together, the method is applicable to activate a program required by the user without opening function menus, and includes the following steps.

Receive a writing track input by the user from a touch module 110 (Step S11). In order to avoid other application programs from disturbing the inputting of the control instruction, an instruction writing module 11 may be configured on the handheld device 10.

Therefore, the instruction writing module 11 may be activated firstly to obtain the control right of the touch module 110 before the inputting of the control instruction, thereby avoiding the disturbance from other application programs.

Touch the touch module 110 and slip on the touch module 110. The manner of touching includes writing on the touch module 110 using a finger or a touch pen.

Touched positions of the touch module 110 are recorded to be converted into a writing track. Generally, a pressure sensing module (not shown) is configured within the touch module 110. The pressure sensing module is used to sense the touched positions of the touch module 110, and record the positions to form the writing track that represents the control instruction ordered by the user.

The writing track is analyzed by using a recognition module 130, so as to convert the writing track into a track data (Step S12). The recognition module 130 converts the writing track into a track data according to characteristics such as line length, amplitude, interlacing of the writing track.

The track data is compared with at least one feature data 141 stored in the memory unit 140 (Step S13).

The feature data 141 stored in the memory unit 140 has two types. One is a grain data corresponding to the line characteristic of the writing track and which is converted from a specific judgment formula. The other is a line pattern formed by capturing the writing track displayed on the display unit 120. Therefore, the recognition module 130 compares the converted track data with the feature data 141 stored in the memory unit 140 in a manner determined by the type of the feature data 141 stored in the memory unit 140.

It is judged whether at least one feature data consistent with the track data exists (Step S14), so as to determine whether to execute a program instruction 142 corresponding to the feature data 141. This step includes two corresponding judging manners according to the type of the feature data 141 stored in the memory unit 140.

When the feature data 141 stored in the memory unit 140 is the grain data, the recognition module 130 converts the writing track input by the user through the touch module 110 into a track data which is the grain data, and searches in the memory unit 140 to judge whether a feature data (the grain data) consistent with the track data exists.

When the feature data 141 stored in the memory unit 140 is the line pattern, the track data converted by the recognition module 130 is a line pattern formed by capturing the writing track displayed on the display unit 120, and the recognition module 130 searches in the memory unit 140 one by one to judge whether the feature data 141 (the line pattern) consistent with the track data exists.

When it is judged that the track data is consistent with the feature data 141, the program instruction 142 corresponding to the feature data 141 is executed (Step S15), so as to activate the application program 143 corresponding to the program instruction 142, and execute the executing action designated by the program instruction 142. Otherwise, when it is judged that the track data is not consistent with the feature data 141, no application program 143 is activated, or a message of unable to recognize the control instruction is output (Step S16).

However, during the judgment, the recognition module 130 first calculates a difference between the track data and the feature data 141. When the difference is less than an error value, it is judged that the track data is consistent with the feature data 141. When it is judged that the track data is consistent with two or more feature data 141, the program instructions 142 corresponding to the feature data 141 are displayed on the display unit 120 for the user to select a program instruction 142 to be executed.

When the program instruction 142 corresponding to the feature data 141 is executed, the program instruction 142 corresponding to the feature data 141 is read firstly, then an application program 143 corresponding to the program instruction 142 is activated, and finally the application program 143 is activated to execute an executing action designated by the program instruction 142.

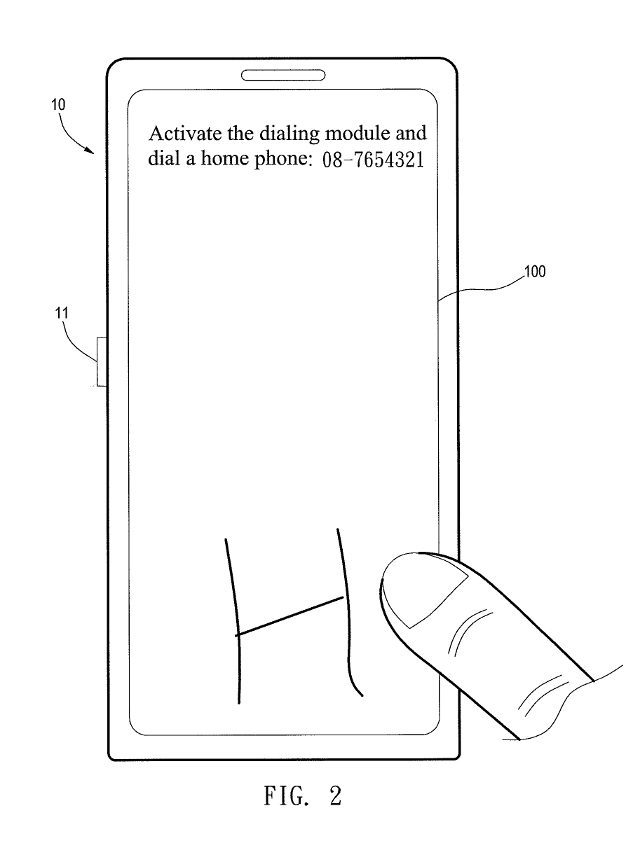

FIGS. 2 to 6 are schematic views of executing the program instruction 142 according to embodiments of the present invention. The handheld device 10 of this embodiment is a mobile phone with a touch screen 100, and the touch screen 100 includes the touch module 110 and the display unit 120. The handheld device 10 is provided with an instruction writing module 11, which may be implemented as a press key device configured to a housing of the handheld device in this embodiment.

Referring to FIG. 2, a schematic view of executing the program instruction 142 according to an embodiment of the present invention is shown, and reference is made to FIG 1A or 1B for further understanding.

In this embodiment, the application program 143 stored in the memory unit 140 is a dialing module, the stored feature data 141 is a text H, and the program instruction 142 corresponding to the feature data 141 of the text H is “activate the dialing module and dial a home phone”. The user first activates the instruction writing module 11 to obtain the control right of the touch screen 100, and writes the text H on the touch screen 100. The touch screen 100 displays the writing track of the text H. The recognition module 130 reads the program instruction 142 corresponding to the feature data 141 of the text H to execute the specific action of “activate the dialing module and dial a home phone”, and displays that on the touch screen 100. As shown in FIG. 2, the touch screen 100 displays a text message of “activate the dialing module and dial a home phone, number: 08-7654321”.

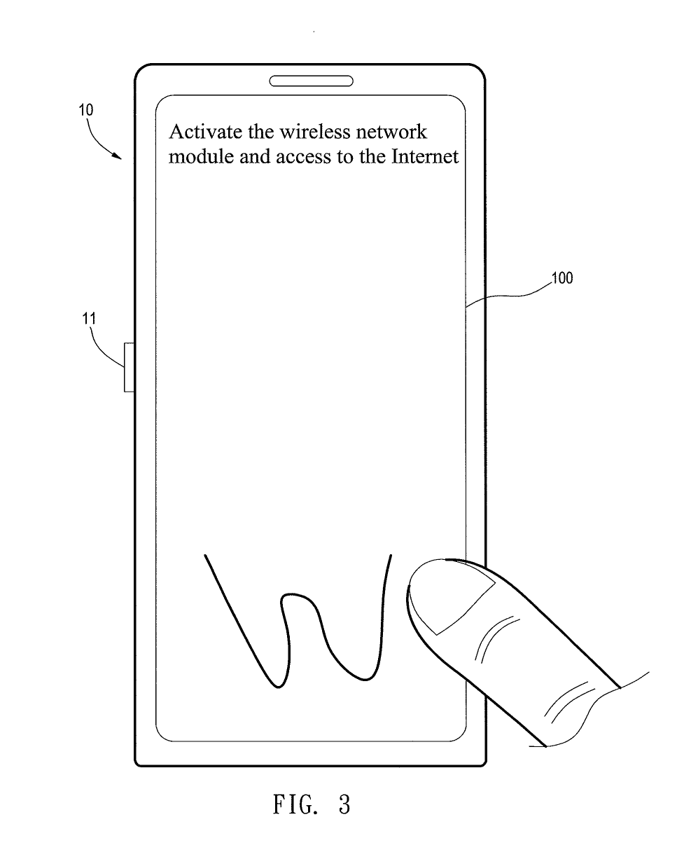

Referring to FIG.3, a schematic view of executing the program instruction 142 according to an embodiment of the present invention is shown, and reference is made to FIG. 1A or 1B for further understanding.

In this embodiment, the application program 143 stored in the memory unit 140 is a wireless network module. The stored feature data 141 is a text W, and the program instruction 142 corresponding to the feature data 141 of the text W is “activate the wireless network module and access to the Internet”.

The user first activates the instruction writing module 11 to obtain the control right of the touch screen 100, and writes the text W on the touch screen 100. The touch screen 100 displays the writing track of the text W. The recognition module 130 reads the program instruction 142 corresponding to the feature data 141 of the text W to execute the specific action of “activate the wireless network module and access to the Internet”, and displays that on the touch screen 100.

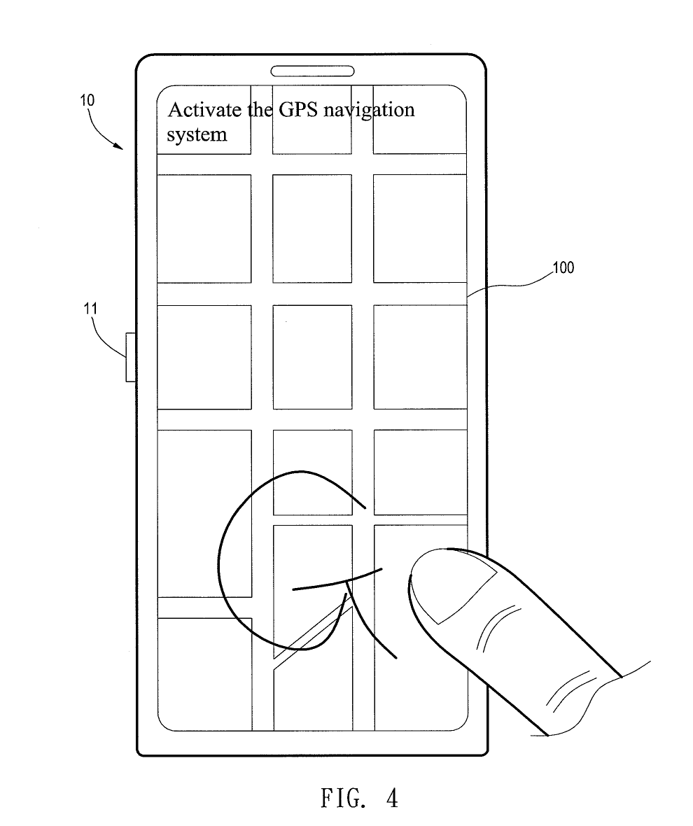

Referring to FIG. 4, a schematic view of executing the program instruction 142 according to an embodiment of the present invention is shown, and reference is made to FIG. 1A or 1B for further understanding.

In this embodiment, the application program 143 stored in the memory unit 140 is an activating program of a Global Positioning System (GPS) navigation system. The stored feature data 141 is a text G, and the program instruction 142 corresponding to the feature data 141 of the text G is “activate the GPS navigation system”.

The user first activates the instruction writing module 11 to obtain the control right of the touch screen 100, and writes the text G on the touch screen 100. The touch screen 100 displays the writing track of the text G. The recognition module 130 reads the program instruction 142 corresponding to the feature data 141 of the text G to execute the specific action of “activate the GPS navigation system”, and displays that on the touch screen 100.

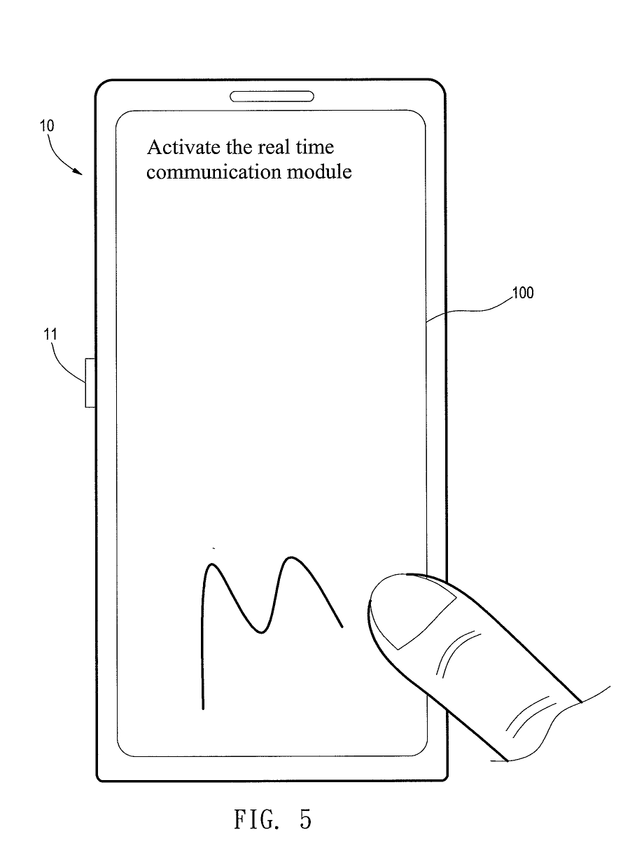

Referring to FIG. 5, a schematic view of executing the program instruction 142 according to an embodiment of the present invention is shown, and reference is made to FIG. 1A or 1B for further understanding.

In this embodiment, the application program 143 stored in the memory unit 140 is a real time communication program. The stored feature data 141 is a text M, and the program instruction 142 corresponding to the feature data 141 of the text is M “activate the real time communication module”.

The user first activates the instruction writing module 11 to obtain the control right of the touch screen 100, and writes the text M on the touch screen 100. The touch screen 100 displays the writing track of the text M. The recognition module 130 reads the program instruction 142 corresponding to the feature data 141 of the text M to execute the specific action of “activate the real time communication module”, and displays that on the touch screen 100.

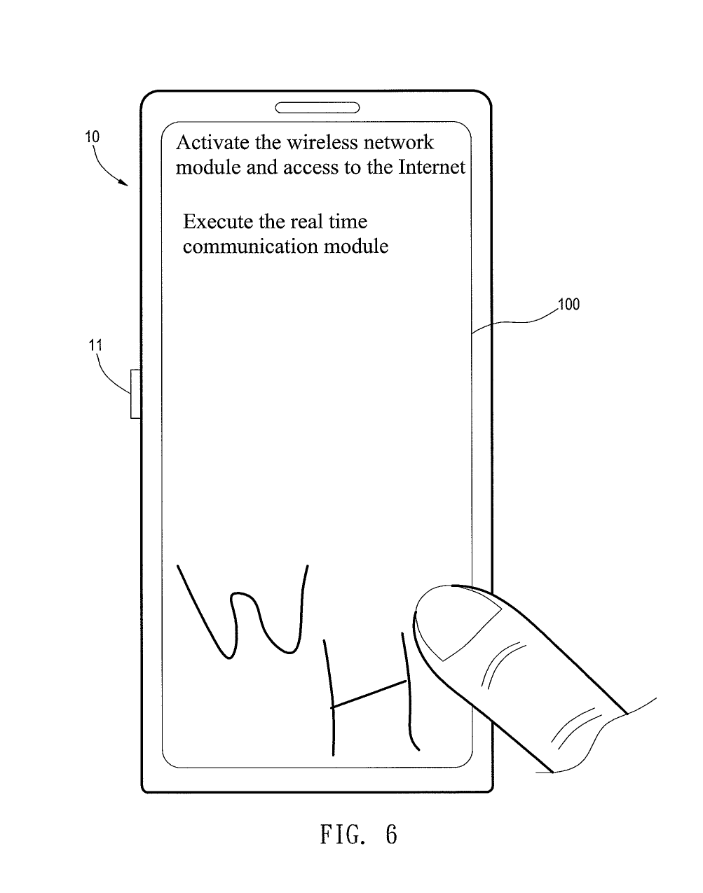

Referring to FIG. 6, a schematic view of executing the program instruction 142 according to an embodiment of the present invention is shown, and reference is made to FIG. 1A or 1B for further understanding. This embodiment is different from the above embodiments in that a plurality of writing tracks are input continuously in this embodiment.

In this embodiment, the application program 143 stored in the memory unit 140 includes a wireless network module and a real time communication program. The stored feature data 141 includes a text M and a text W. The program instruction 142 corresponding to the feature data 141 of the text M is “activate the real time communication module”, and the program instruction 142 corresponding to the feature data 141 of the text W is “activate the wireless network module and access to the Internet”.

The user first activates the instruction writing module 11 to obtain the control right of the touch screen 100, and writes the text WM on the touch screen 100. The touch screen 100 displays the writing tracks of the text WM. The recognition module 130 first reads the program instruction 142 corresponding to the feature data 141 of the text W to execute the specific action of “activate the wireless network module and access to the Internet”. After that, the recognition module 130 continuously reads the program instruction 142 corresponding to the feature data 141 of the text M to execute the specific action of “activate the real time communication module”. Thus, a specific action of “activate the wireless network module to access to the Internet and activate the real time communication module to input a real time message” is formed and displayed on the touch screen 100. However, in addition to configuring the instruction writing module 11 described above as a press key device, if the handheld device has a keyboard or an assemble keypad such as a dial keypad of the mobile phone, the instruction writing module 11 may be integrated into the keyboard or the assembled keypad. Moreover, the instruction writing module 11 may be further programmed to form an instruction writing program, and meantime be installed on the handheld device having an embedded operating system and a touch module.

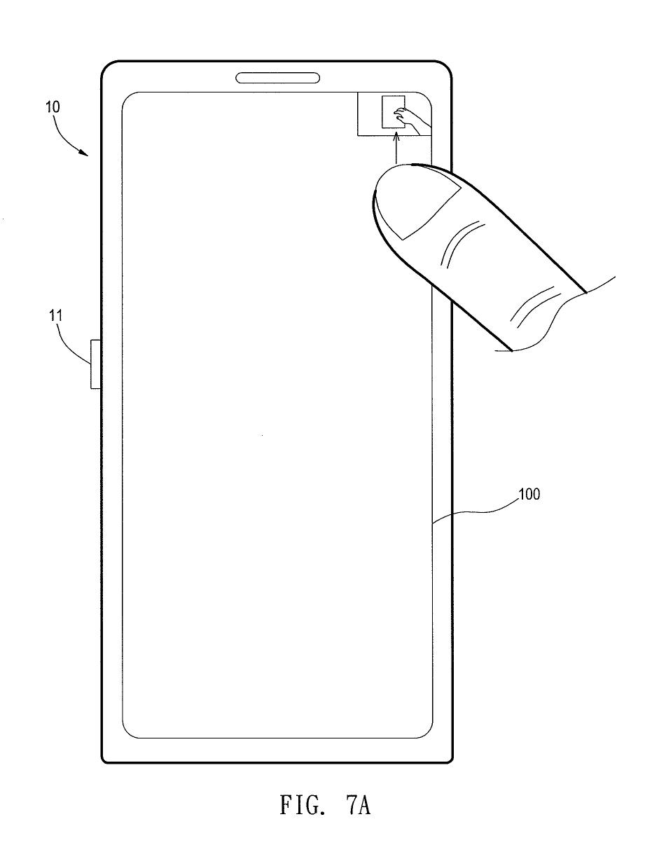

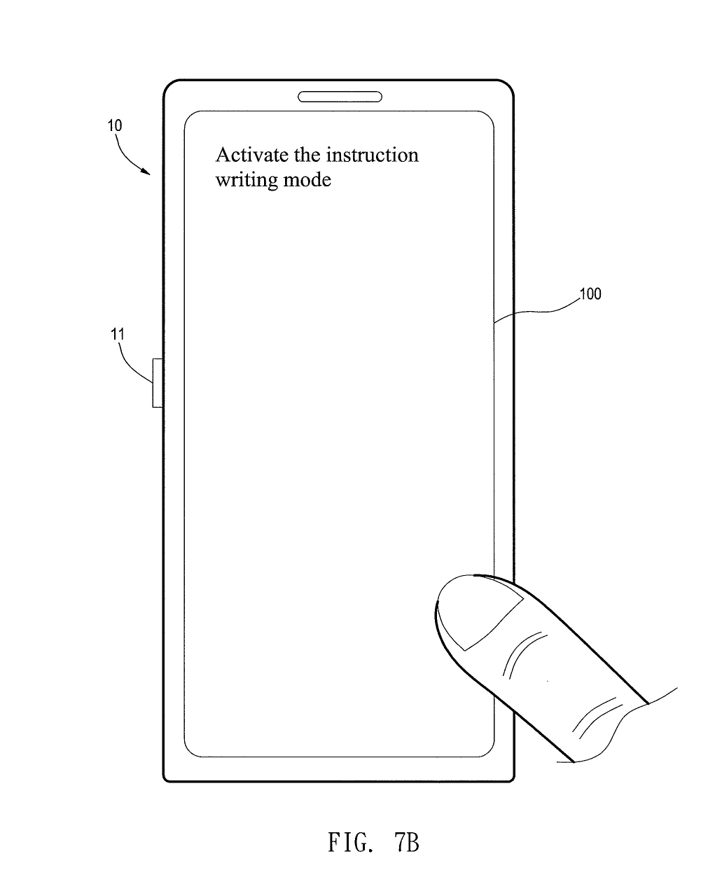

Referring to FIGS. 7A and 7B, schematic views of configuration and operation of programming the instruction writing module according to the present invention are shown.

As shown in FIG. 7A, the instruction writing module 11 is programmed to form an instruction writing program, and is built in the operating system of the handheld device 10. Meantime, a specific area is designated on the display area of the display unit 120 or the touch module 100 to configure a picture key (or a hot key) corresponding to the instruction writing module 11. In this embodiment, the specific area is disposed to the upper right corner of the display area, but the present invention is not limited thereto. The specific area may be also disposed on the upper left corner, lower right corner, and lower left corner of the display, or on a programmed digital keyboard.

The instruction writing module 11 is activated when the user presses the picture key. As show in FIG. 7B, when the instruction writing module 11 is activated, the display unit 120 or the touch screen 100 displays prompt statements such as “activate the instruction writing mode, and input the writing instruction:”, for prompting the user to write a writing track on the touch module 110 or the touch screen 100 for the recognition of the recognition module 130, so as to activate the related application program 143.

Although the present invention is disclosed as the preferred embodiment described above, however, it is not used to limit the present invention. The equivalent alternatives of the alterations and modifications made by any skilled in the art without departing from the spirit and scope of the present invention still fall in the scope of the claims of the present invention.

What is claimed is:

1. A method of inputting a control instruction of a handheld device, applicable to activate a program required by a user without opening function menus, comprising steps of:
receiving a writing track input by the user from a touch module;
analyzing the writing track by a recognition module to convert the writing track into a track data;
comparing the track data with at least one feature data stored in a memory unit; and
judging whether at least one feature data consistent with the track data exists, so as to determine whether to execute a program instruction corresponding to the feature data.

2. The method of inputting a control instruction of a handheld device according to claim 1, wherein in the step of judging whether at least one feature data consistent with the track data exists, when it is judged that the track data is consistent with the feature data, the program instruction corresponding to the feature data is executed.

3. The method of inputting a control instruction of a handheld device according to claim 1, wherein in the step of judging whether at least one feature data consistent with the track data exists, when it is judged that the track data is consistent with a plurality of feature data, the program instructions corresponding to the feature data are displayed on a display unit to provide for selecting a program instruction to be executed.

4. The method of inputting a control instruction of a handheld device according to claim 1, wherein the program instruction is an executing action of an application program corresponding to the feature data.

5. The method of inputting a control instruction of a handheld device according to claim 1, wherein the step of receiving a writing track input by the user from a touch module comprises steps of:
activating an instruction writing module to obtain a control right of the touch module; and
recording touched positions of the touch module when the user touches the touch module and slips on the touch module to form a writing track.

6. The method of inputting a control instruction of a handheld device according to claim 5, wherein the instruction writing module is a press key device configured to a housing of the handheld device.

7. The method of inputting a control instruction of a handheld device according to claim 5, wherein the instruction writing module is a press key device configured to a keyboard of the handheld device.

8. The method of inputting a control instruction of a handheld device according to claim 5, wherein the instruction writing module is an instruction writing program configured to a specific area of a display area of the handheld device and activated by touching the touch module.

9. The method of inputting a control instruction of a handheld device according to claim 1, wherein the handheld device further comprises an update step which is provided to update the feature data, the application program, and the program instruction stored in the memory unit.

10. A handheld device for inputting a control instruction, applicable to activate a program required by a user without opening function menus, comprising:
a memory unit, storing at least one feature data, at least one application program, and at least one program instruction, wherein each feature data is corresponding to one program instruction, and the program instruction is used to activate one application program;
a touch module, for being touched to form a writing track; and
a recognition module, for analyzing the writing track as a track data, and determining the feature data in the memory unit which is consistent with the track data, so as to execute the program instruction corresponding to the feature data.

11. The handheld device for inputting a control instruction according to claim 10, further comprising an instruction writing module, wherein the instruction writing module obtains a control right of the touch module when being activated, so as to input the writing track by using the touch module.

12. The handheld device for inputting a control instruction according to claim 11, wherein the instruction writing module is a press key device configured to a housing of the handheld device.

13. The handheld device for inputting a control instruction according to claim 11, wherein the instruction writing module is a press key device configured to a keyboard of the handheld device.

14. The handheld device for inputting a control instruction according to claim 11, wherein the instruction writing module is an instruction writing program configured to a specific area of a display area of the handheld device and activated by touching the touch module.

15. The handheld device for inputting a control instruction according to claim 10, further comprising a display unit, wherein when the recognition module judges that the track data is consistent with a plurality of feature data, the program instructions corresponding to the feature data are displayed on the display unit for being selected by the user.

16. The handheld device for inputting a control instruction according to claim 15, further comprising a touch screen, wherein the touch screen comprises the display unit and the touch module.

17. The handheld device for inputting a control instruction according to claim 10, further comprising an update module, for updating the feature data, the application program, and the program instruction stored in the memory unit.

18. The handheld device for inputting a control instruction according to claim 10, wherein the recognition module compares the track data and the feature data stored in the memory unit, and when a difference between the track data and the feature data is calculated to be less than an error value, it is judged that the track data is consistent with the feature data, and the program instruction corresponding to the feature data is executed.

19. The handheld device for inputting a control instruction according to claim 10, wherein the handheld device is a mobile phone, a Personal Digital Assistant (PDA), or a notebook computer.

20. The handheld device for inputting a control instruction according to claim 10, wherein when the recognition module executes the program instruction corresponding to the feature data, the application program executes a specific action designated by the program instruction.
